(19) United States
(12) Patent Application Publication
(10) Pub. No.: US 2006/0075099 A1
(43) Pub. Date: Apr. 6, 2006

(54) Automatic elimination of viruses and spam

(76) Inventors: Malcolm E. Pearson, Kirkland, WA (US); Leon R. Warman, Kirkland, WA (US); Robert G. Atkinson, Woodinville, WA (US); David R. Reed, Seattle, WA (US); Steven D. White, Bellevue, WA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/942,632

(22) Filed: Sep. 16, 2004

(51) Int. Cl. G06F 15/173

(52) U.S. Cl. 709/225

(57) ABSTRACT

The present invention utilizes honeypots, which are messaging system resources set up to attract unauthorized or illicit use thereof, for automatically identifying messages with malignant content. As messages are received at a honeypot, fingerprints of the messages are generated, which correspond to pattern information within the messages. These fingerprints are then used to determine a confidence level that messages received at a legitimate messaging service are malignant. Based on the confidence level, various actions (e.g., deleting the malignant content) may be executed.

### CROSS-REFERENCE TO RELATED APPLICATIONS

N/A

### BACKGROUND OF THE INVENTION

1. The Field of the Invention

The present invention generally relates to electronic messaging systems. More specifically, the present invention provides for automatically detecting malignant messages using pattern information from messages received by a honeypot, honeynet or other similar messaging system resource.

2. Background and Related Art

Message systems have become an increasingly popular way to communicate. These communication systems range from email systems to secured transactions, from instant messaging chat rooms to various web services such as Internet shopping. Although the wide spread use of such messaging systems has transformed the way we live and work, its growth in popularity is also an attractive target for attackers. For example, such messaging systems are venerable, to receiving unwanted and unsolicited malignant messages, such as “SPAM” and viruses.

“SPAM” has been around virtually as long as there have been electronic messaging systems. Historically, the annoyance and burden of SPAM (though noticeable) was small enough so as not to be a significant problem. More recently, however, the rate at which SPAM has been appearing in user's electronic mailboxes, or in other communications such as instant messaging, has significantly increased. It is not uncommon for large commercial electronic mailbox provides to routinely observe that well over half or even three-quarters of messages received by their users are SPAM. The problem has become one of significant proportions, costing users, industry, and the economy at large significant time and financial resources; threatening perhaps the viability of electronic messaging systems as useful communication medium.

Sometimes used as attachments to SPAM messages, viruses have become an even more increasing area of concern for messaging systems. Some viruses wreak their effect as soon as their code is executed; while other viruses lay dormant until circumstances cause their code to be executed by the computer. Viruses, e.g., worms, Trojan horses, etc., come in a wide range of complexity and malicious intent. Some viruses are benign or playful in intent; however, the majority of viruses are more malicious in using valuable computer recourses, accessing personal or private information for fraudulent purposes and even causing a full infection of the messaging system.

A number of techniques have been developed to classify electronic messages as malignant in order to distinguish them from other legitimate electronic messages. Some techniques examine received electronic messages and classify a received message as malignant based on the semantics, e.g., words or phrases, found therein. Other techniques for classifying malignant messages take advantage of the fact that messages that are malignant are typically sent to a large number of users. These alternative techniques use collective voting approaches to identify electronic message as malignant. Another common and particularly useful technique is the maintenance, on a user's behalf, of a list of known correspondence—an approach commonly referred to as whitelisting and/or blacklisting.

After classifying a message as malignant, such messages may be treated differently then legitimate mail. For example, malignant message may automatically be moved to a junk folder, or possibly the malignant content (or even the entire message) may be deleted. Although such techniques help identify and eliminate the receipt of malignant messages, typical malignant message filters require a significant amount of manual input. For example, as described above for blacklists and whitelists, a user needs to evaluate that a message does or does not contain malignant content and manually add the senders email address to the appropriate list. Similarly, when generating semantics, a manual process of first identifying those messages that are thought to be malignant and then posting them to a central server must usually be performed. Accordingly, to adapt to changing malignant messages, a significant amount of user maintenance is needed. As such, there exists a need for a messaging system that can automatically detect and eliminate malignant messages even in changing environments.

### BRIEF SUMMARY OF THE INVENTION

The above-identified deficiencies and drawbacks of current messaging systems are over come by the present invention. In a messaging system for communicating information between users, the present invention provides for automatically detecting malignant messages using information from messages received by one or more honeypots.

A honeypot is a messaging system resource set up to attract unauthorized or illicit use thereof. Exemplary embodiments provide for receiving a message destined for legitimate user account at a message service. Based upon one or more messages received at a honeypot, exemplary embodiments provide for automatically calculating a confidence level that the received message includes malignant content for determining what action to take thereon.

Other exemplary embodiments provide for receiving a first message at a message system resource set up to attract unauthorized or illicit use thereof. A potential message fingerprint is generated, which corresponds to pattern information within the first message. Further, a second message is received at a message service that receives messages for one or more legitimate users. A regular message fingerprint is then generated, which corresponds to pattern information within the second message. The potential malignant fingerprint is compared with the regular message fingerprint. Based on the comparison, one or more malignant fingerprints are generated for use in automatically calculating a confidence level that messages received at the message service includes malignant content.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a messaging system network for generating malignant fingerprints in accordance with example embodiments of present invention;

FIG. 1B illustrates the use of malignant fingerprints for detecting malignant messages and taking actions thereon in accordance with example embodiments;

FIG. 1C illustrates a clearinghouse for storing and using malignant fingerprints from various organizations in accordance with example embodiments of the present invention;

FIG. 2 illustrates a flow chart of a method of automatically detecting malignant messages in accordance with example embodiments of present invention;

FIG. 3 illustrates an example system that provides a suitable operating environment for the present invention.

### DETAILED DESCRIPTION OF THE PREFERRED EMBODIMENTS

The present invention extends to methods, systems and computer program products for automatically detecting malignant messages and taking action thereon. The embodiments of the present invention may comprise a special purpose or general-purpose computer including various computer hardware, as discussed in greater detail below.

Exemplary embodiments utilize information received by honeypots, honey nets, and/or any other messaging system resource that is primarily set up to attract unauthorized or illicit use thereof. Such messaging system resources come in a wide variety of forms. For example, honeypots can be low-interaction software used to emulated services, servers, mailboxes, and other system resources. Further, these messaging system resources can be high-interaction, e.g., honeynets, which are architectures of an entire network of computers designed to be attacked. Other forms of honeypots are also well known in the industry. Accordingly, the present invention is not limited to any particular form of honeypot; and therefore, the term honeypot should be broadly construed to encompass any type of service, server, mailbox(s), IP address, software application, web service, or any other well known messaging resource whose primary function lies in unauthorized or illicit use of that resource.

In addition, it is noted that the use of the term “message service” should be broadly construed to be any type of service, server, mailbox, collection of mailboxes, IP address, software application, web service, or any other well known messaging system resource associated with electronic messages. As such, any specific reference to a particular messaging resource as described herein is used for illustrative purposes only and is not meant to limit or otherwise narrow the scope of the present invention unless explicitly claim.

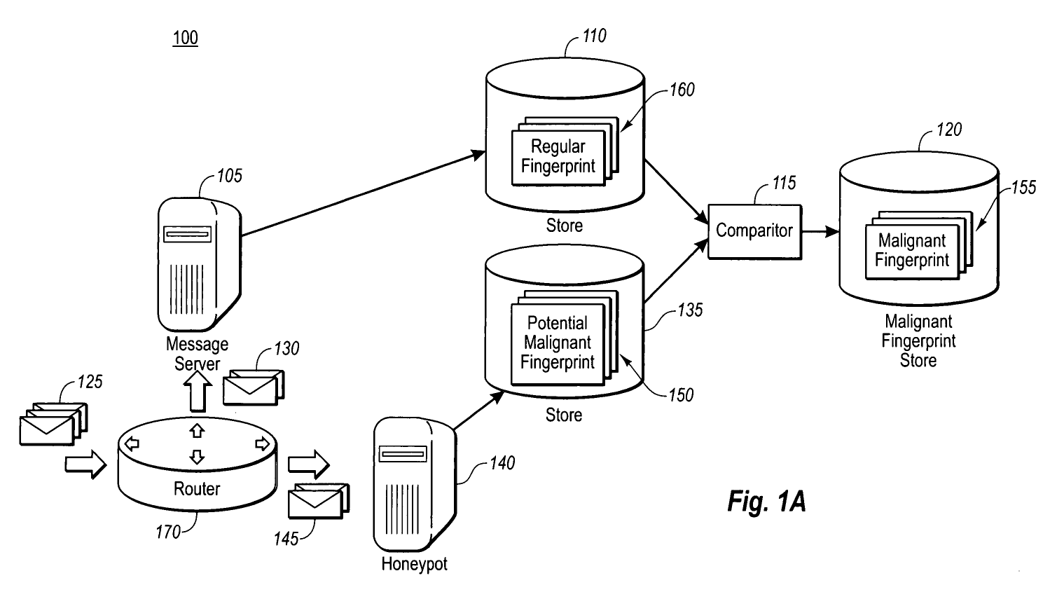

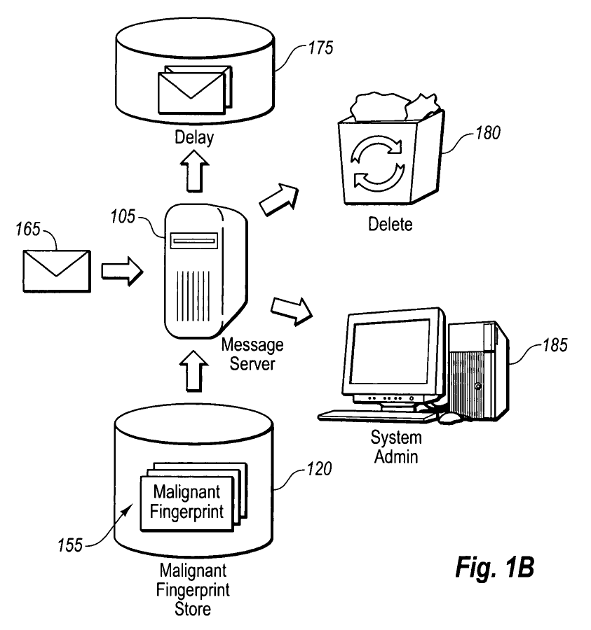

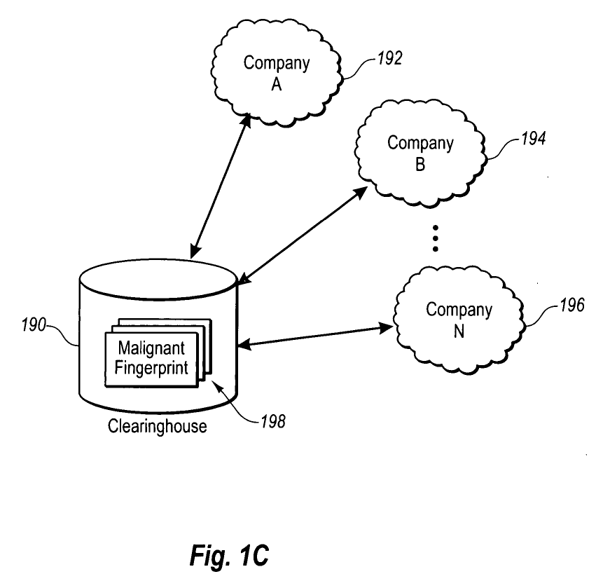

Theoretically, a honeypot should see no traffic because it has no legitimate activity. This means any interaction with a honeypot is most likely unauthorized or malicious activity. Any connection attempts to a honeypot are most likely a probe, attack, or compromise. FIG. 1A illustrates a messaging system network 100 that utilizes a honeypot 140 for generating malignant fingerprints 155 in accordance with example embodiments of the present invention. As messages 125 (e.g., instant messages, electronic mail messages, etc.) are received in the network they are routed, e.g., using router 170, to either message service 105 or honeypot 140. The system 100 is configured to identify messages 130 that are destined to legitimate users of the messaging system 100, which are routed to message service 105 for subsequent distribution to the appropriate user. Potential malignant messages 145, i.e., messages that are destined for fictitious or otherwise non-existing users, are routed to honeypot 140.

As one would recognize, there are several different ways that messages may be identified as potentially malignant and routed to honeytpot 140. For example, specific IP addresses may be set up within honeypot 140, wherein messages with such addresses are routed appropriately. Alternatively, any message with a domain name corresponding to message service 105, but with no legitimate user name, may be identified and sent to honeypot 140. Of course, other ways of identifying messages as potential malignant are also available to the present invention. For instance, if router 170 is configured to be aware of SMTP, then any individual address that is unique may be identified as potentially malignant. Accordingly, the above described methods for determining those messages 145 to route to honeypot 140 are used for illustrative purposes only and are not meant to limit or otherwise narrow the scope of the present invention unless explicitly claimed.

Regardless of the routing technique for the messages 125, example embodiments provide that messages 125 received in messaging network 100 are scanned to generate fingerprints thereof, which correspond to pattern information within the messages 125. For example, after message service 105 receives legitimate message 130, they can be scanned to create regular fingerprints 160 that can subsequently be stored in fingerprints store 110. Similarly, potential malignant messages 145 received at honeypot 140 are scanned to generate potential malignant fingerprints 150 that are stored in fingerprint store 135. As will be described in greater detail below, both sets of fingerprints 160, 150—either individually or combined—can be used in determining messages that include malignant content.

It should be noted, that although the honeypot 140 and message service 105 are shown as separate entities, as well as a separation of fingerprints 150, 160 into different stores 110, 135, other configurations are available. For example, the message service 105 and honeypot 140 may be combined on a single machine. Further, the separate stores 110, 135 may also reside on the same machine. In fact, as one would recognize, there are a number of different configurations for practicing exemplary embodiments of the present invention; and therefore, any diagram of a particular configuration as used within the context of this application is for illustrative purposes only and it is not meant to limit or otherwise narrow the scope of the present invention.

As one would recognize, fingerprints 150, 160 can be generated in numerous ways and can be representative of any portion of content within the messages 125. Moreover, there may be multiple fingerprints generated from a single message. For example, fingerprints may be a hash of the messages 125, or one or more portions thereof. Alternatively, or in conjunction, the fingerprints 150, 160 may be a semantic pattern or patterns within the messages 125, e.g., words, phrases, paragraphs, or even a whole document. Further, the fingerprints 150, 160 could be an attachment or other content associated with the message. Of course, any other unique way of representing content or any portion or portions thereof within a message is also available to the present invention. Accordingly, the term “fingerprint” as used in the present invention should broadly be construed to include all forms and ways to represent content for comparison purposes and should not be limited to any particular form unless otherwise explicitly claimed.

Once fingerprints 150, 160 are generated, comparator 115 can then be utilized to compare the fingerprints 150, 160 for generating malignant fingerprints 155 within store 120. For example, comparator 115 can compare potential malignant fingerprints 150 with regular fingerprints 160. Those potential malignant fingerprints 150 that are the most distinguished from the regular fingerprints 160 may be determined to be malignant fingerprints 155. That is, because the potential malignant fingerprints 150 generated are more probable than not malignant, and because regular fingerprints 160 are more likely to be from legitimate messages, those potential malignant fingerprints 150 that are the most distinct from the regular fingerprints 160 can provide an even higher probability that they were generated from malignant messages.

Of course, other types of comparison may be made in order to determine malignant fingerprints 155. For example, potential malignant fingerprints 150 can be compared with each other and if a large number of potential malignant fingerprints 150 match then there is a high probability that these are malignant fingerprints 155. Alternatively, all messages received at the honeypot 140 can be assumed malignant, and thus all potential malignant fingerprints 150 can be considered malignant 155. As one would recognize, there are many other ways of identifying and comparing fingerprints in order to determine those that are malignant 155. As such, the present invention is not limited to any particular technique or comparison for determining those fingerprints 155 that are malignant based on messages received in honeypot 140; and therefore, the above examples are used for illustrative purposes only and are not meant to limit or otherwise narrow the scope of the present invention unless explicitly claimed.

Once the malignant fingerprints 155 are generated, they can then be used for identifying malignant messages received at message service 105. For example, as shown in FIG. 1B, as message 165 is received at message service 105 the contents thereof can be compared with malignant fingerprints 155, wherein if the message matches one or more of the malignant fingerprints 155 an appropriate action may be taken. The action taken may be any one of a number of various tasks. For example, if the message 165 is determined to be malignant, it maybe deleted 180 or sent to a system administrator 185 for further evaluation. Alternatively, or in conjunction, it may be quarantined in delay 175. As one would recognize, there are many other various actions that may be taken on the message, e.g., sending a non-delivery receipt back to a client (not shown) that sent the message 165. Accordingly, the above examples of action taken on potential or actual malignant messages are used for illustrative purposes only and are not meant to limit or otherwise narrow the scope of the present invention unless explicitly claimed.

Further, these actions may be based on a myriad of conditions. For example, as described in greater detail below, they may be based on the percentage that the malignant fingerprints match content within message 165. Further, the actions may be based on the confidence level that the malignant fingerprints 155 are themselves representative of malignant content. Utilizing such conditions, message service 105 can create a confidence level that message 165 is malignant, and based on that confidence level various actions may be preformed.

As briefly mentioned above, in another embodiment, the impact on the message may be dialed according to the specificness of malignant mail fingerprints 155. For example, if the malignant fingerprints 155 match ten percent of the regular message 165 traffic, then the appropriate action may be to delay 175 the message 165 until further confidence that the message 165 is indeed malignant can be determined. On the other hand, if the malignant fingerprint 155 matches a very small percentage of the traffic, e.g., 0.01 percent, then the confidence level that the message is malignant is high; and therefore the appropriate action may be to delete 108 the message. Of course, there are a number of different ways in which the malignant fingerprints 155 can be used to determine a confidence level that a message 165 is malignant and the actions that can be taken based thereon. Accordingly, the above examples for using malignant fingerprints 155 for identifying message 165 as malignant, and the actions taken based thereon, are used for used for illustrative purposes only and are not meant to limit or otherwise narrow the scope of the present invention.

In still yet other exemplary embodiments, messaging system 100 can utilize other malignant fingerprints generated from other organizations or companies. For example, as shown in FIG. 1C, malignant fingerprints 198 identified by other organizations may be stored in a central clearinghouse 190. These malignant fingerprints 198 may have been generated by trusted companies, e.g., company A (192), company B (194), or any number of companies as indicated by the vertical ellipsis above company N (126). These malignant fingerprints 198 may be used by the various companies 192, 194, 196—either individually or in conjunction with there own malignant fingerprints—for determining messages within their own organization that are malignant.

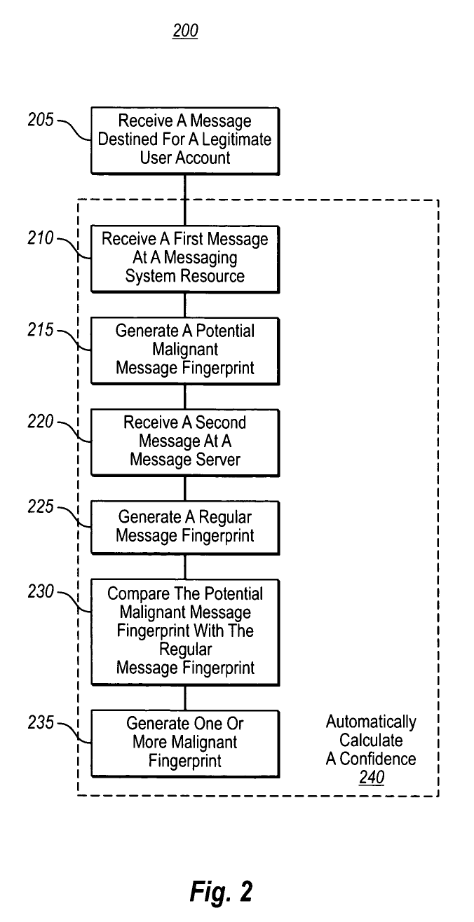

The present invention may also be described in terms of methods comprising functional steps and/or non-functional acts. The following is a description of steps and acts that may be preformed in practicing the present invention. Usually, functional steps describe the invention in terms of results that are accomplished where as non-functional acts describe more specific actions for achieving a particular result. Although the functional steps and non-functional acts may be described or claimed in a particular order, the present invention in not necessarily limited to any particular ordering or combination of steps and/or acts. Further, the use of steps and/or acts in the recitation of the claims and the following description of the flow chart for FIG. 2 are used to indicate the desired specific use of such terms.

FIG. 2 illustrates an example flow chart for various exemplary embodiments of the present invention. The following description of FIG. 2 will occasionally refer to corresponding elements from FIGS. 1A and 1B. Although reference may be made to a specific element from these Figures, such elements are used for used for illustrative purposes only and are not meant to limit or otherwise narrow the scope of the present invention unless explicitly claimed.

FIG. 2 illustrates an example flow chart of a method 200 of automatically detecting malignant messages using information from messages received by one or more honeypots. Method 200 includes an act of receiving 205 a message destined for a legitimate user account. For example, message service 105 may receive legitimate messages 130. Method 200 further includes a step for automatically calculating 240 a confidence level. For example, honeypot 140—which is a messaging system resource set up to attract unauthorized or illicit use thereof—may receive potential malignant messages 145. Based on one or more of the messages 145 received at honeypot 140, a confidence level that the receive messages includes malignant content may be automatically calculated for determining what action 175, 180, 185 to take thereon.

The confidence level may be based on the number of matches of malignant fingerprints 155, which correspond to pattern information within one or more messages 145 received at the honeypot 140. Alternatively, or in conjunction, the confidence level may be based on the number of matches that malignant fingerprints 155 have with the messages 130 received at the message service 105. The malignant fingerprint 155 may be one or more of a hash or semantic pattern of at least a portion of the one or more messages 145 received at honeypot 140.

As an example of the above step 240, step 240 includes an act of receiving 210 a first message at a messaging systems resource. For example, honeypot 140 may receive a first message from messages 145. Step 240 also includes an act of generating 215 a potential malignant fingerprint. For example, based upon the content within the received first message 145, potential malignant fingerprints 150 may be generated. Next, step 240 includes an act of receiving 220 a second message at a message service. Moreover, step 240 includes an act of generating 225 a regular message fingerprint. For example, message service 105 may receive messages 130 that are intended for one or more legitimate users. Based upon the contents and pattern information within the legitimate messages 130, regular fingerprints 160 may be generated.

Step 240 further includes an act of comparing 230 the potential malignant message fingerprint with the regular message fingerprint. Further, step 240 includes an act of generating 235 one or more malignant fingerprints. For example, comparator 115 may compare regular fingerprints 160 to potential malignant fingerprint 150, wherein based on the comparison one or more malignant fingerprints 155 may be generated for use in automatically calculating a confidence level that messages received at the message service 105 include malignant content.

Other exemplary embodiments provide for receiving a message 165 at a message service 105 and comparing the message 165 with one or more malignant fingerprints 155. Based upon the comparison, a confidence level that the message 165 includes malignant content may be determined. The confidence level may then be compared with a threshold value for determining what actions to take on the message.

Still other exemplary embodiments provide for comparing the one or more malignant fingerprints 155 with other malignant fingerprints 150 corresponding to the messaging system resource 140. The confidence level may then be further based on the number of matches determined from such comparison. The malignant fingerprints may be one or more of a hash or semantic pattern of at least a portion of messages received at the messaging system resource 140.

In still yet other exemplary embodiments, a clearinghouse 190 may be accessed, which is a data base with a collection of other malignant fingerprints 198 from other organizations 192, 194, 196. The malignant fingerprints 198 correspond to pattern information within messages that include malignant content. The other malignant messages fingerprints 198 may be received, wherein the calculations of the confidence level may further be based on the other malignant fingerprints 198 received from the clearinghouse 190. The present invention also extends to instant messaging. Accordingly, the received message at that message service 105 may be an instant message.

Still other exemplary embodiments provide for various actions that can be taken based on the determined confidence level. For example, based on the determined-confidence level the action to take on the message may be to delay 175 the message 165. Additional messages 145 may be received at the messaging system resource 140 and based on the additional messages 145 received a new confidence level may be automatically calculated for determining what actions 175, 180, 185 to take on the message. The actions may be one or more of a deleting 180 the message 165, deleting 180 the malignant content, sending a non-delivery receipt back to a client that sent the message 165, or forwarding the message to a system administrator 185.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

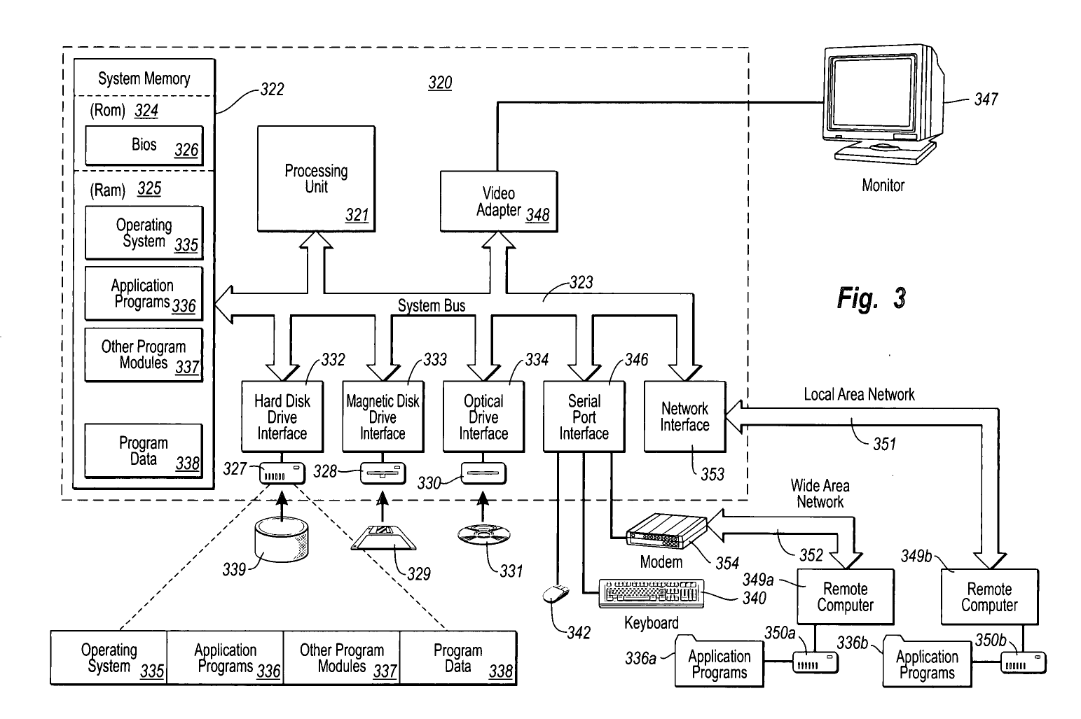

FIG. 3 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 3, an exemplary system for implementing the invention includes a general purpose computing device in the form of a conventional computer 320, including a processing unit 321, a system memory 322, and a system bus 323 that couples various system components including the system memory 322 to the processing unit 321. The system bus 323 may be any of several types of bus structures including a memory bus or memory controller, a peripheral bus, and a local bus using any of a variety of bus architectures. The system memory includes read only memory (ROM) 324 and random access memory (RAM) 325. A basic input/output system (BIOS) 26, containing the basic routines that help transfer information between elements within the computer 320, such as during start-up, may be stored in ROM 24.

The computer 320 may also include a magnetic hard disk drive 27 for reading from and writing to a magnetic hard disk 339, a magnetic disk drive 328 for reading from or writing to a removable magnetic disk 329, and an optical disk drive 330 for reading from or writing to removable optical disk 331 such as a CD-ROM or other optical media. The magnetic hard disk drive 327, magnetic disk drive 328, and optical disk drive 330 are connected to the system bus 323 by a hard disk drive interface 332, a magnetic disk drive-interface 333, and an optical drive interface 334, respectively. The drives and their associated computer-readable media provide nonvolatile storage of computer-executable instructions, data structures, program modules and other data for the computer 320. Although the exemplary environment described herein employs a magnetic hard disk 339, a removable magnetic disk 329 and a removable optical disk 331, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 339, magnetic disk 329, optical disk 331, ROM 324 or RAM 325, including an operating system 335, one or more application programs 336, other program modules 337, and program data 338. A user may enter commands and information into the computer 320 through, keyboard 340, pointing device 342, or other input devices (not shown), such as a microphone, joy stick, game pad, satellite dish, scanner, or the like. These and other input devices are often connected to the processing unit 321 through a serial port interface 346 coupled to system bus 323. Alternatively, the input devices may be connected by other interfaces, such as a parallel port, a game port or a universal serial bus (USB). A monitor 347 or another display device is also connected to system bus 323 via an interface, such as video adapter 348. In addition to the monitor, personal computers typically include other peripheral output, devices (not shown), such as speakers and printers.

The computer 320 may operate in a networked environment using logical connections to one or more remote computers, such as remote computers 349a and 349b. Remote computers 349a and 349b may each be another personal computer, a server, a router, a network PC, a peer device or other common network node, and typically include many or all of the elements described above relative to the computer 320, although only memory storage devices 350a and 350b and their associated application programs 336a and 336b have been illustrated in FIG. 3. The logical connections depicted in FIG. 3 include a local area network (LAN) 351 and a wide area network (WAN) 352 that are presented here by way of example and not limitation. Such networking environments are commonplace in office-wide or enterprise-wide computer networks, intranets and the Internet.

When used in a LAN networking environment, the computer 320 is connected to the local network 351 through a network interface or adapter 353. When used in a WAN networking environment, the computer 320 may include a modem 354, a wireless link, or other means for establishing communications over the wide area network 352, such as the Internet. The modem 354, which may be internal or external, is connected to the system bus 323 via the serial port interface 346. In a networked environment, program modules depicted relative to the computer 320, or portions thereof, may be stored in the remote memory storage device. It will be appreciated that the network connections shown are exemplary and other means of establishing communications over wide area network 352 may be used. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a messaging system for communicating information between users, a method of automatically detecting malignant messages using information from messages received by one or more honeypots, the method comprising:
an act of receiving, at a message service, a message destined for a legitimate user account; and
based on one or more messages received at a honeypot, which is a messaging system resource set up to attract unauthorized or illicit use thereof, a step for automatically calculating a confidence level that the received message includes malignant content for determining what action to take thereon.

2. The method of claim 1, further comprising acts of:
accessing a clearing house, which is a database with a collection of malignant fingerprints from other organizations; and
receiving one or more of the malignant fingerprints, which correspond to pattern information within messages that include malignant content, wherein the calculation of the confidence level is further based on the other malignant fingerprints received from the clearing house.

3. The method of claim 1, wherein the confidence level is based on the number of matches of malignant fingerprints, the malignant fingerprints corresponding to pattern information within the one or more messages received at the honeypot.

4. The method of claim 3, wherein the malignant fingerprints are one or more of a hash or semantic pattern of at least a portion of the one or more messages received at the honeypot.

5. The method of claim 1, wherein the confidence level is based on the number of matches that malignant fingerprints have with messages received at the message service, the malignant fingerprints corresponding to pattern information within the one or more messages received at the honeypot.

6. The method of claim 5, wherein the malignant fingerprints are one or more of a hash or semantic pattern of at least a portion of the one or more messages received at the honeypot.

7. The method of claim 1, wherein the message received at the message service is an instant message.

8. The method of claim 1, further comprising acts of:
based on the determined confidence level, delaying the action to take on the message;
receiving additional messages at the honeypot; and
based on the addition messages received, automatically calculating a new confidence level for determining what actions to take on the message.

9. The method of claim 8, wherein the actions are one or more of a deleting the message, deleting the malignant content, sending a non-delivery receipt back to a client that sent the message or forwarding the message to a system administrator.

10. In a messaging system for communicating messages between users, a method of automatically detecting malignant messages using pattern information from messages received by one or more messaging system resources and a regular message service, the method comprising acts of:
receiving a first message at a messaging system resource set up to attract unauthorized or illicit use thereof;
generating a potential malignant fingerprint, which corresponds to pattern information within the first message;
receiving a second message at a message service that receives messages for one or more legitimate users;
generating a regular message fingerprint, which corresponds to pattern information within the second message;
comparing the potential malignant fingerprint with the regular message fingerprint; and
based on the comparison, generating one or more malignant fingerprints for use in automatically calculating a confidence level that messages received at the message service include malignant content.

11. The method of claim 10, further comprising acts of:
receiving a message at the message service;
comparing the message with the one or more malignant fingerprints;
based on the comparison, determining a confidence level that the message includes malignant content; and
comparing the confidence level to one or more threshold values for determining what action to take on the message.

12. The method of claim 11, further comprising an act of:
comparing the one or more malignant fingerprints with other malignant fingerprints corresponding to the messaging system resource, wherein the confidence level is further based on the number of matches determined from such comparison.

13. The method of claim 12, wherein the one or more malignant fingerprints are one or more of a hash or semantic pattern of at least a portion of messages received at the messaging system resource.

14. The method of claim 11, further comprising acts of:
accessing a clearing house, which is a database with a collection of other malignant fingerprints from other organizations; and
receiving one or more of the other malignant fingerprints, which correspond to pattern information within messages that include malignant content, wherein the calculation of the confidence level is further based on the other malignant fingerprints received from the clearing house.

15. The method of claim 11, wherein the message received at the message service is an instant message.

16. The method of claim 11, further comprising acts of:
based on the determined confidence level, delaying the action to take on the message;
receiving additional messages at the messaging system resource; and
based on the addition messages received, automatically calculating a new confidence level for determining what actions to take on the message.

17. The method of claim 16, wherein the actions are one or more of a deleting the message, deleting the malignant content, sending a non-delivery receipt back to a client that sent the message or forwarding the message to a system administrator.

18. In a messaging system for communicating messages between users, a method of automatically detecting malignant messages using pattern information from messages received by one or more messaging system resources, the method comprising acts of:
receiving a first plurality of messages at a messaging system resource set up to attract unauthorized or illicit use thereof;
generating potential malignant fingerprints for each of the first plurality of messages, the potential malignant fingerprints corresponding to pattern information within each of the first plurality of messages;
receiving a second plurality of messages at a message service that receives messages for one or more legitimate users;
generating regular message fingerprints for the second plurality of messages, the regular message fingerprints corresponding to pattern information within each of the second plurality of messages;
comparing the potential malignant fingerprints with the regular message fingerprints; and
based on the comparison, generating one or more malignant fingerprints for use in automatically calculating a confidence level that messages received at the message service include malignant content.

19. The method of claim 18, further comprising acts of:
receiving a message at the message service;
comparing the message with the one or more malignant fingerprints;
based on the comparison, determining a confidence level that the message includes malignant content; and
comparing the confidence level to one or more threshold values for determining what action to take on the message.

20. The method of claim 19, further comprising an act of:
comparing the one or more malignant fingerprints with other malignant fingerprints corresponding to the messaging system resource, wherein the confidence level is further based on the number of matches determined from such comparison.

21. The method of claim 20, wherein the one or more malignant fingerprints are one or more of a hash or semantic pattern of at least a portion of messages received at the messaging system resource.

22. The method of claim 19, further comprising acts of:
accessing a clearing house, which is a database with a collection of other malignant fingerprints from other organizations; and
receiving one or more of the other malignant fingerprints, which correspond to pattern information within messages that include malignant content, wherein the calculation of the confidence level is further based on the other malignant fingerprints received from the clearing house.

23. The method of claim 19, wherein the message received at the message service is an instant message.

24. The method of claim 19, further comprising acts of:
based on the determined confidence level, delaying the action to take on the message;
receiving additional messages at the messaging system resource; and
based on the addition messages received, automatically calculating a new confidence level for determining what actions to take on the message.

25. The method of claim 24, wherein the actions are one or more of a deleting the message, deleting the malignant content, sending a non-delivery receipt back to a client that sent the message or forwarding the message to a system administrator.

26. A computer program product for use in a messaging system for communicating information between users, the computer program product for implementing a method of automatically detecting malignant messages using information from messages received by one or more honeypots, the computer program product comprising one or more computer readable media having stored thereon computer executable instructions that, when executed by a processor, can cause the distributed computing system to perform the following:
receive, at a message service, a message destined for a legitimate user account; and
based on one or more messages received at a honeypot, which is a messaging system resource set up to attract unauthorized or illicit use thereof, automatically calculate a confidence level that the received message includes malignant content for determining what action to take thereon.

27. The computer program product of claim 26, further comprising computer executable instructions that:
access a clearing house, which is a database with a collection of malignant fingerprints from other organizations; and
receive one or more of the malignant fingerprints, which correspond to pattern information within messages that include malignant content, wherein the calculation of the confidence level is further based on the other malignant fingerprints received from the clearing house.

28. The computer program product of claim 26, wherein the confidence level is based on the number of matches of malignant fingerprints, the malignant fingerprints corresponding to pattern information within the one or more messages received at the honeypot.

29. The computer program product of claim 28, wherein the malignant fingerprints are one or more of a hash or semantic pattern of at least a portion of the one or more messages received at the honeypot.

30. The computer program product of claim 26, wherein the confidence level is based on the number of matches that malignant fingerprints have with messages received at the message service, the malignant fingerprints corresponding to pattern information within the one or more messages received at the honeypot.

31. The computer program product of claim 30, wherein the malignant fingerprints are one or more of a hash or semantic pattern of at least a portion of the one or more messages received at the honeypot.

32. The computer program product of claim 26, further comprising computer executable instructions that:
based on the determined confidence level, delay the action to take on the message;
receive additional messages at the honeypot; and
based on the addition messages received, automatically calculate a new confidence level for determining what actions to take on the message.

33. The computer program product of claim 32, wherein the actions are one or more of a deleting the message, deleting the malignant content, sending a non-delivery receipt back to a client that sent the message or forwarding the message to a system administrator.

34. A computer program product for use in a messaging system for communicating messages between users, the computer program product used to implement a method of automatically detecting malignant messages using pattern information from messages received by one or more messaging system resources and a regular message service, the computer program product comprising one or more computer readable media having stored thereon computer executable instructions that, when executed by a processor, can cause the distributed computing system to perform the following:
receive a first message at a messaging system resource set up to attract unauthorized or illicit use thereof;
generate a potential malignant fingerprint, which corresponds to pattern information within the first message;
receive a second message at a message service that receives messages for one or more legitimate users;
generate a regular message fingerprint, which corresponds to pattern information within the second message;
compare the potential malignant fingerprint with the regular message fingerprint; and
based on the comparison, generate one or more malignant fingerprints for use in automatically calculating a confidence level that messages received at the message service include malignant content.

35. The computer program product of claim 34, further comprising computer executable instructions that:
receive a message at the message service;
compare the message with the one or more malignant fingerprints;
based on the comparison, determine a confidence level that the message includes malignant content; and
compare the confidence level to one or more threshold values for determining what action to take on the message.

36. The computer program product of claim 35, further comprising computer executable instructions that:
compare the one or more malignant fingerprints with other malignant fingerprints corresponding to the messaging system resource, wherein the confidence level is further based on the number of matches determined from such comparison.

37. The computer program product of claim 36, wherein the one or more malignant fingerprints are one or more of a hash or semantic pattern of at least a portion of messages received at the messaging system resource.

38. The computer program product of claim 37, further comprising computer executable instructions that:
access a clearing house, which is a database with a collection of other malignant fingerprints from other organizations; and
receive one or more of the other malignant fingerprints, which correspond to pattern information within messages that include malignant content, wherein the calculation of the confidence level is further based on the other malignant fingerprints received from the clearing house.

39. The computer program product of claim 37, further comprising computer executable instructions that:
based on the determined confidence level, delay the action to take on the message;
receive additional messages at the messaging system resource; and
based on the addition messages received, automatically calculate a new confidence level for determining what actions to take on the message.

40. The computer program product of claim 39, wherein the actions are one or more of a deleting the message, deleting the malignant content, sending a non-delivery receipt back to a client that sent the message or forwarding the message to a system administrator.
